(19) United States
(12) Patent Application Publication
(10) Pub. No.: US 2016/0047446 A1
(43) Pub. Date: Feb. 18, 2016

(54) DUAL-SCREW LINEAR ACTUATOR

(71) Applicant: MOTECK ELECTRIC CORP., New Taipei City (TW)

(72) Inventor: Chih-Li HUNG, New Taipei City (TW)

(21) Appl. No.: 14/819,072

(22) Filed: Aug. 5, 2015

(30) Foreign Application Priority Data
Aug. 18, 2014 (TW) 103214730

(51) Int. Cl. F16H 25/20

(52) U.S. Cl. CPC F16H 25/20; F16H 2025/2031; F16H 2025/209

(57) ABSTRACT

A dual-screw linear actuator includes a power drive unit including a gear set mounted in a holder frame thereof and a driver for rotating the gear set, a transmission mechanism including a sleeve coupled to and rotatable by the gear set, a tubular linkage rod mounted in and rotatable by the sleeve and having a first threaded connection portion and a second threaded connection portion respectively located at two opposite ends thereof, a first lead screw threaded into the first threaded connection portion and affixed to the holder frame for guiding movement of the tubular linkage rod forwardly/backwardly relative to the first lead screw upon rotation of the tubular linkage rod and a second lead screw threaded into the second threaded connection portion and movable forwardly/backwardly relative to the tubular linkage rod upon rotation of the tubular linkage rod.

This application claims the priority benefit of Taiwan patent application number 103214730, filed on Aug. 18, 2014.

### BACKGROUND OF THE INVENTION

1. Field of the Invention

The present invention relates to linear actuator technology and more particularly, to a dual-screw linear actuator, which comprises a power drive unit, and a transmission mechanism that comprises a sleeve rotatable by the power drive unit, a tubular linkage rod rotatable by the sleeve, and a first lead screw and a second lead screw respectively threaded into two opposite ends of the tubular linkage rod for linear movement relative to the tubular linkage rod upon rotation of the linear linkage rod by the sleeve.

2. Description of the Related Art

Linear actuators with different mechanical and transmission designs are known for use in electric beds, electric tables, massage chairs, fitness and rehabilitation equipments, lifting mechanisms and many other electrically controllable devices for elevation or angular position adjustment.

A conventional linear actuator generally comprises a two-stage sliding assembly and connected between a fixed member and a movable member of a device. One sliding unit of the sliding assembly is movable linearly relative to the other sliding unit to adjust the distance between the fixed member and the movable member. A two-stage sliding assembly of this kind simply comprises a first member, and a second member coupled to the first member and axially movable relative to the first member to adjust the overall length of the two-stage sliding assembly. The stroke of a two-stage actuator is always shorter than the shortest retracted length of the actuator. Longer stroke needs longer retracted length of the actuator. To satisfy some market requirements for stroke of actuator longer than the retracted length, various mechanism of 3-stage, 4-stage, or multi-stage sliding assemblies were developed to break the above said limit. Another benefit is the higher moving speed of the multi-stage sliding assembly than a 2-stage one through simultaneously relative movements of all the sliding units. Nowadays, linear actuators with multi-stage sliding assemblies have wide applications in the market.

### SUMMARY OF THE INVENTION

The present invention has been accomplished under the circumstances in view. It is one object of the present invention to provide a dual-screw linear actuator that eliminates the drawbacks of the aforesaid prior art linear actuator.

To achieve this and other objects of the present invention, a dual-screw linear actuator comprises a power drive unit and a transmission mechanism. The transmission mechanism comprises a sleeve rotatable by a gear set of the power drive unit and defining therein an axially extended accommodation hole, a tubular linkage rod mounted in and rotatable by the sleeve and having a first threaded connection portion and a second threaded connection portion respectively located at two opposite ends thereof, a first lead screw threaded into the first threaded connection portion and having a mounting portion located at one end thereof and affixed to the holder frame for guiding movement of the tubular linkage rod forwardly/backwardly relative to the first lead screw upon rotation of the tubular linkage rod and a second lead screw threaded into the second threaded connection portion and movable forwardly/backwardly relative to the tubular linkage rod upon rotation of the tubular linkage rod. Thus, using the power drive unit to rotate the sleeve of the transmission mechanism and to further drive the tubular linkage rod to move the first lead screw and the second lead screw greatly enhances the normal force of the linear transmission, ensuring a high level of transmission stability.

Preferably, the dual-screw linear actuator further comprises a sliding assembly affixed to the power drive unit and coupled to the transmission mechanism. The sliding assembly comprises a first sliding unit, a second sliding unit and a third sliding unit. The first sliding unit has one end thereof directly affixed to said holder frame and an opposite end thereof coupled to one end of the second sliding unit. The third sliding unit has one end thereof slidably coupled to an opposite end of the second sliding unit, and an opposite end thereof connected to the second lead screw for enabling the third sliding unit to be synchronously linearly moved with the second lead screw relative to the second sliding unit. When the power drive unit is started to rotate the gear set and the sleeve, the tubular linkage rod is rotated by the sleeve to move the first lead screw and second lead screw linearly, causing a pushing portion of the second lead screw to move the third sliding unit linearly relative to the second sliding unit in adjusting the height of the external apparatus in which the dual-screw linear actuator is installed.

Other advantages and features of the present invention will be fully understood by reference to the following specification in conjunction with the accompanying drawings,.

### BRIEF DESCRIPTION OF THE DRAWINGS

FIG. 1 is an oblique top elevational view of a dual-screw linear actuator in accordance with the present invention.

FIG. 2 is an exploded view of the dual-screw linear actuator in accordance with the present invention.

FIG. 3 corresponds to FIG. 2 when viewed from another angle.

FIG. 4 is a sectional side view of the invention, illustrating the sliding assembly of the dual-screw linear actuator fully extended.

FIG. 5 corresponds to FIG. 4, illustrating the length of the sliding assembly of the dual-screw linear actuator partially extended.

FIG. 6 corresponds to FIG. 5, illustrating the sliding assembly of the dual-screw linear actuator in the fully retracted condition.

### DETAILED DESCRIPTION OF THE PREFERRED EMBODIMENT

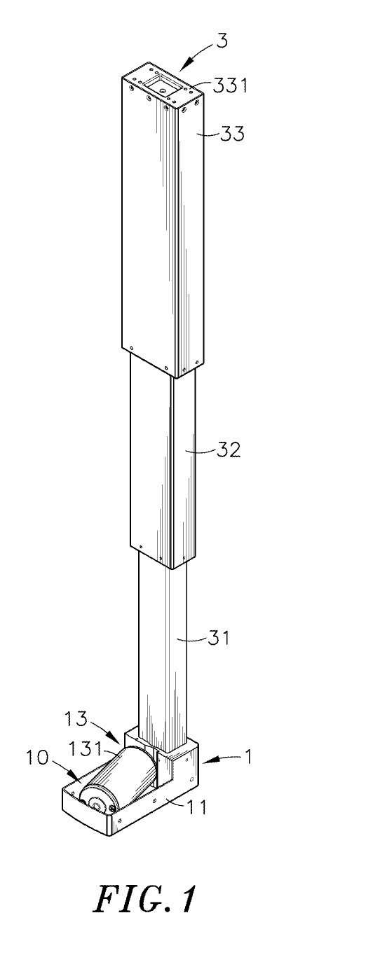

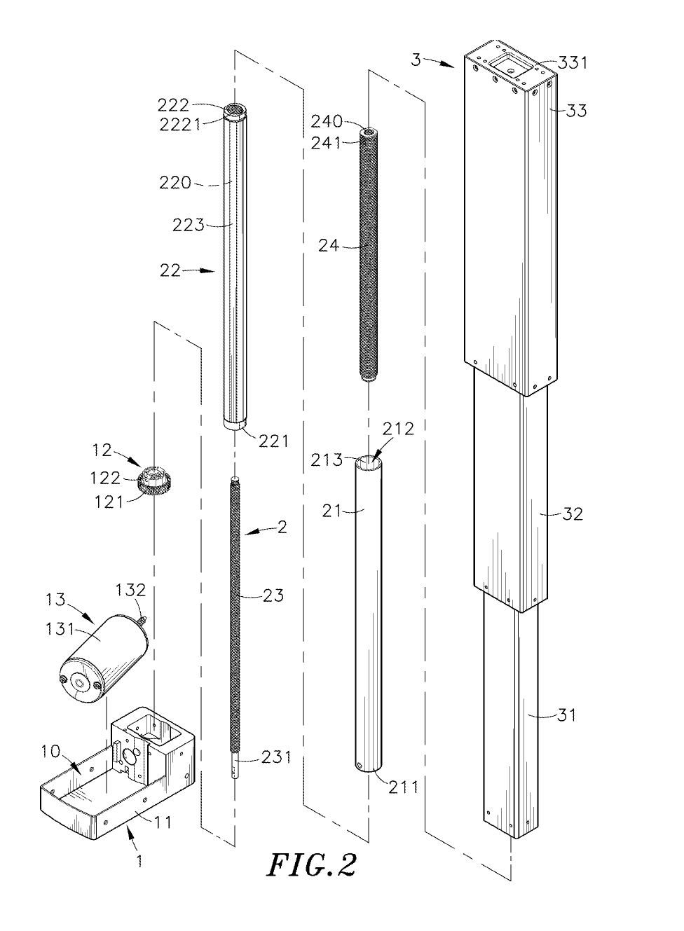

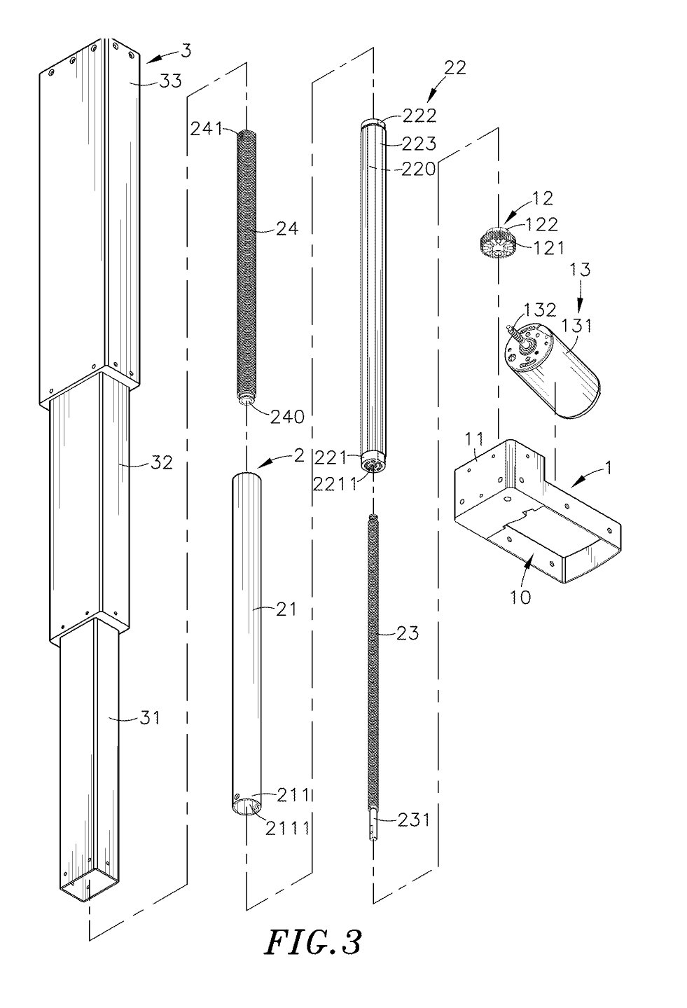

Referring to FIGS. 1-3, an oblique top elevational view of a dual-screw linear actuator, an exploded view of the dual-screw linear actuator and another exploded view of the dual-screw linear actuator are shown. As illustrated, the dual-screw linear actuator comprises a power drive unit 1 and a transmission mechanism 2.

The power drive unit 1 comprises a hollow holder frame 11 defining therein an accommodation chamber 10, a gear set 12 mounted in the accommodation chamber 10 and comprising a driven gear (such as: worm gear) 121 having a gear shaft 122 extended out of two opposite sides thereof at the center, a driver 13 mounted on the inside (or outside) of the holder frame 11 and comprising a motor 131, and a driving shaft (such as: worm) 132 meshed with the driven gear 121 of the gear set 12 and rotatable by the motor 131.

The transmission mechanism 2 comprises a sleeve 21. The sleeve 21 comprises a connection portion 211 located at one end thereof, a locating hole 2111 defined in the connection portion 211 and press-fitted onto one end of the gear shaft 122 of the driven gear 121 for enabling the sleeve 21 to be synchronously rotated with the gear set 12 upon operation of the motor 131, an accommodation hole 212 axially extended through the two opposite ends of the sleeve 21, and at least one bearing surface portion 213 located at the inside wall of the accommodation hole 212.

The transmission mechanism 2 further comprises a tubular linkage rod 22, a first lead screw 23, and a second lead screw 24. The tubular linkage rod 22 is mounted in the accommodation hole 212 of the sleeve 21. Further, the tubular linkage rod 22 comprises an axial through-hole 220 axially extended through two opposite ends thereof, a first threaded connection portion 221 located at one end of the axial through-hole 220 and defining therein a first screw hole 2211, and a second threaded connection portion 222 located at an opposite end of the axial through-hole 220 and defining therein a second screw hole 2221. The first threaded connection portion 221 and the second threaded connection portion 222 can be independent components respectively fastened to the tubular linkage rod 22 by a screw joint or welding. The first lead screw 23 and the second lead screw 24 are respectively threaded into the first screw hole 2211 and second screw hole 2221 of the tubular linkage rod 22. The tubular linkage rod 22 further comprises an abutment surface portion 223 located on the periphery thereof for abutment against the bearing surface portion 213 in the accommodation hole 212 of the sleeve 21 to cause synchronous rotation of the tubular linkage rod 22 with the sleeve 21.

The first lead screw 23 comprises a mounting portion 231 located at one end thereof. The mounting portion 231 of the first lead screw 23 is inserted through the center of the driven gear 121 of the gear set 12 into a mounting hole (not shown) inside of the holder frame 11 and affixed thereto with a pin, screw or other fastening member in such a manner that rotating the gear set 12 does not cause the first lead screw 23 to rotate. The second lead screw 24 comprises an axial passage 240 extending through the two opposite ends thereof for the insertion of the opposite end of the first lead screw 23 for enabling the first lead screw 23 to be moved axially in and out of the sleeve 21, and a pushing portion 241 located at the opposite end thereof remote from the tubular linkage rod 22.

The dual-screw linear actuator further comprises a sliding assembly 3 affixed to the power drive unit 1 and coupled to the transmission mechanism 2. The sliding assembly 3 comprises a first sliding unit 31, a second sliding unit 32 and a third sliding unit 33 that fit and slide one within another. The first sliding unit 31 has its one end directly abutted against or affixed to a part inside the holder frame 11 and its other end coupled to the second sliding unit 32. The third sliding unit 33 has its one end slidably coupled to the second sliding unit 32, and its other end provided with a top plate 331. The pushing portion 241 of the second lead screw 24 is fixedly fastened to the top plate 331 of the third sliding unit 33. Thus, the dual-screw linear actuator of the present invention can be used in an external apparatus (such as electric bed, electric table, massage chair, lifting mechanism, or any other device or equipment), letting the holder frame 11 and the third sliding unit 33 be respectively pivotally connected to an immovable member and a movable member of the external apparatus with screws or pivot pins. After installation in the external apparatus, the power drive unit 1 can be controlled to drive the transmission mechanism 2 in moving the sliding assembly 3 linearly to adjust the distance between the immovable member and movable member of the external apparatus.

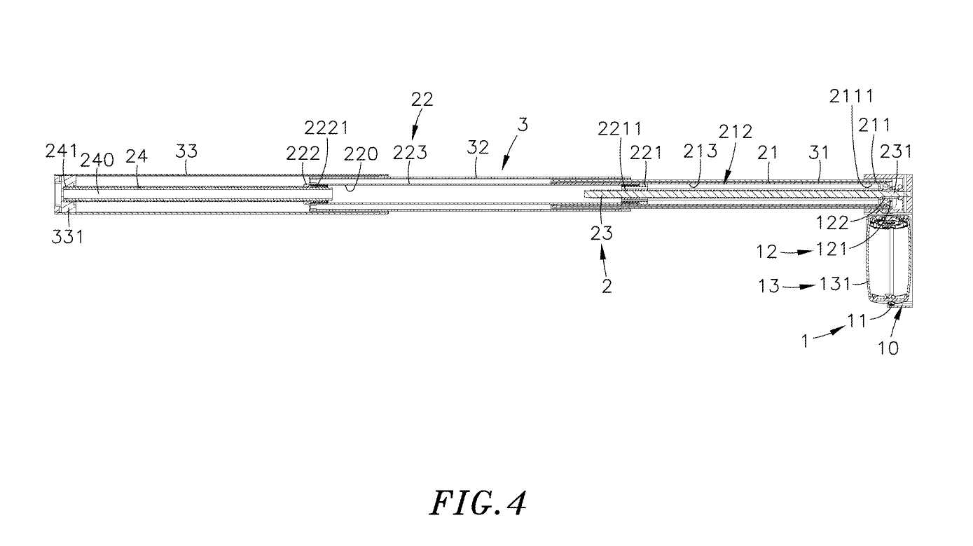

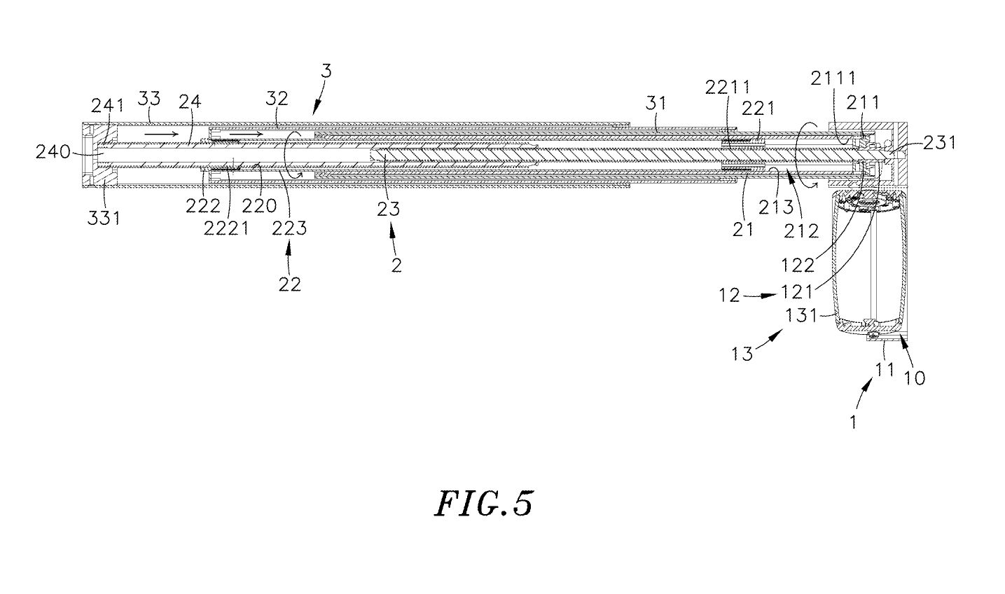

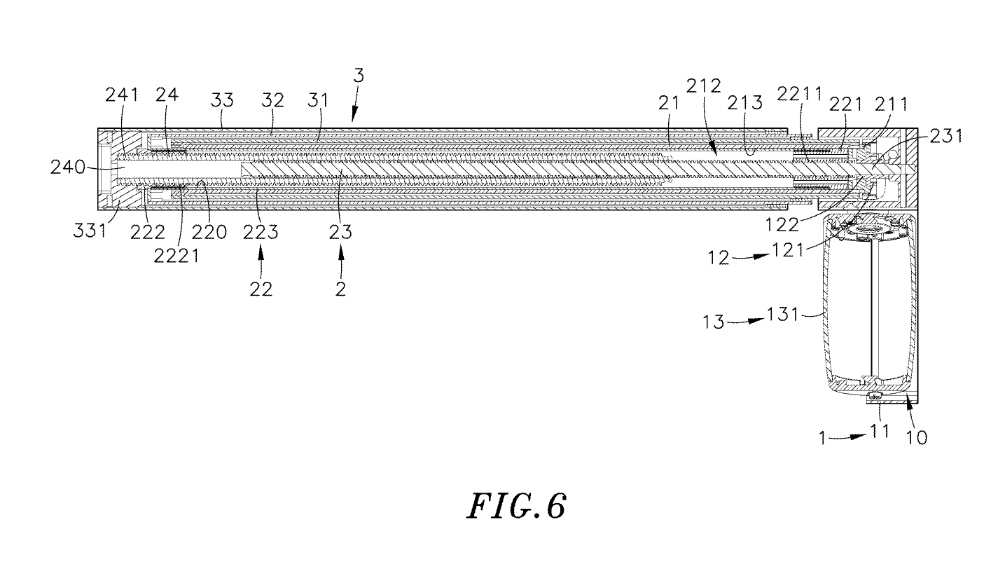

Referring to FIGS. 4, 5 and 6, sectional side views of the sliding assembly of the dual-screw linear actuator in the fully extended condition, partially extended condition and fully retracted condition are shown. As illustrated, when starting the motor 131 of the driver 13 to rotate the driving shaft 132, the driven gear 121 of the meshed gear set 12 is driven to rotate the sleeve 21 of the transmission mechanism 2 via the gear shaft 122, causing the bearing surface portion 213 in the accommodation hole 212 of the sleeve 21 to abut against the abutment surface portion 223 of the tubular linkage rod 22 and to further move the tubular linkage rod 22, and thus, the tubular linkage rod 22 is synchronously rotated with the sleeve 21. During rotation of the tubular linkage rod 22, the first threaded connection portion 221 and second threaded connection portion 222 of the tubular linkage rod 22 are forced to move the first lead screw 23 and the second lead screw 24 inwardly or outwardly relative to the tubular linkage rod 22, thus, subject to the arrangement that the mounting portion 231 of the first lead screw 23 is affixed to the inside of the holder frame 11 and the pushing portion 241 of the second lead screw 24 is fixedly connected to the top plate 331 of the third sliding unit 33, the tubular linkage rod 22 and the second lead screw 24 are moved linearly relative to the first lead screw 23 to extend/shorten the length of the transmission mechanism 2, and, at the same time, the pushing portion 241 of the second lead screw 24 is forced to move the third sliding unit 33 linearly relative to the second sliding unit 32 to extend/shorten the length of the sliding assembly 3, adjusting the height of the external apparatus. This structural design of using the power drive unit 1 to rotate the sleeve 21 of the transmission mechanism 2 and to further drive the tubular linkage rod 22 to move the first lead screw 23 and the second lead screw 24 greatly enhances the normal force of the linear transmission, ensuring a high level of transmission stability.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A dual-screw linear actuator, comprising:
a power drive unit comprising a holder frame, a gear set mounted in said holder frame, and a driver mounted in said holder frame and adapted for driving said gear set to rotate; and
a transmission mechanism comprising a sleeve coupled to and rotatable by said gear set, said sleeve comprising an accommodation hole axially extending through two opposite ends thereof, a tubular linkage rod mounted in said accommodation hole and rotatable by said sleeve, said tubular linkage rod comprising a first threaded connection portion and a second threaded connection portion respectively located at two opposite ends thereof, a first lead screw threaded into said first threaded connection portion for guiding movement of said tubular linkage rod forwardly/backwardly relative to said first lead screw upon rotation of said tubular linkage rod and a second lead screw threaded into said second threaded connection portion and movable forwardly/backwardly relative to said tubular linkage rod upon rotation of said tubular linkage rod, said first lead screw comprising a mounting portion located at one end thereof and fixedly mounted in said holder frame.

2. The dual-screw linear actuator as claimed in claim 1, wherein said holder frame of said power drive unit defines therein an accommodation chamber; said gear set comprises a driven gear, said driven gear comprising a gear shaft extended out of two opposite sides thereof at the center; said sleeve of said transmission mechanism comprises a connection portion located at one end thereof and connected to said gear shaft of said driven gear for synchronous rotation with said sleeve.

3. The dual-screw linear actuator as claimed in claim 2, wherein said driver of said power drive unit comprises a motor and a driving shaft meshed with said driven gear of said gear set and rotatable by said motor.

4. The dual-screw linear actuator as claimed in claim 1, wherein said sleeve of said transmission mechanism further comprises a bearing surface portion located in said accommodation hole; said tubular linkage rod comprises an axial through-hole axially connected between said first threaded connection portion and said second threaded connection portion, and an abutment surface portion located at the periphery thereof for abutment against said bearing surface portion in said accommodation hole for enabling said tubular linkage rod to be rotated by said sleeve.

5. The dual-screw linear actuator as claimed in claim 1, wherein said tubular linkage rod further comprises a first screw hole and a second screw hole respectively located in said first threaded connection portion and said second threaded connection portion and respectively meshed with said first lead screw and said second lead screw.

6. The dual-screw linear actuator as claimed in claim 1, wherein said first lead screw of said transmission mechanism comprises said mounting portion located at one end thereof and fixedly mounted in said holder frame; said second lead screw comprises an axial passage axially extending through two opposite ends thereof for receiving said first lead screw.

7. The dual-screw linear actuator as claimed in claim 1, further comprising a sliding assembly affixed to said power drive unit and coupled to said transmission mechanism, said sliding assembly comprising a first sliding unit, a second sliding unit and a third sliding unit, said first sliding unit having one end thereof directly affixed to said holder frame and an opposite end thereof coupled to one end of said second sliding unit, said third sliding unit having one end thereof slidably coupled to an opposite end of said second sliding unit and an opposite end thereof provided with a top plate, said top plate being connected to said second lead screw for enabling said third sliding unit to be synchronously linearly moved with said second lead screw relative to said second sliding unit.

8. The dual-screw linear actuator as claimed in claim 7, wherein said second lead screw of said transmission mechanism comprises a pushing portion located at one end thereof remote from said tubular linkage rod and fixedly connected to said top plate of said third sliding unit.
